(19) United States
(12) Patent Application Publication
(10) Pub. No.: US 2009/0016339 A1
(43) Pub. Date: Jan. 15, 2009

(54) APPARATUS, METHOD, AND COMPUTER PROGRAM PRODUCT FOR RELAYING MESSAGES

(76) Inventors: Yoshimichi Tanizawa, Kanagawa (JP); Naoki Esaka, Kanagawa (JP); Tsutomu Shibata, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/043,494

(22) Filed: Mar. 6, 2008

(30) Foreign Application Priority Data
Jul. 12, 2007 (JP) 2007-183334

(51) Int. Cl. H04L 12/28

(52) U.S. Cl. 370/389

(57) ABSTRACT

A call-forwarding destination judging unit included in an SIP proxy estimates whether call forwarding will be required, based on the type of an SIP message. When it has been estimated that call forwarding will be required, the call-forwarding destination judging unit also estimates the destination of the call forwarding. With this arrangement, when the delivery of the SIP message requires call forwarding, it is possible to establish, in advance, a TLS connection with the SIP terminal being the destination of the call forwarding. Thus, it is possible to eliminate the need to establish the TLS connection at the time when the call is actually forwarded.

### CROSS-REFERENCE TO RELATED APPLICATIONS

This application is based upon and claims the benefit of priority from the prior Japanese Patent Application No. 2007-183334, filed on Jul. 12, 2007; the entire contents of which are incorporated herein by reference.

### BACKGROUND OF THE INVENTION

1. Field of the Invention

The present invention relates to a relaying apparatus, a communication method, and a communication computer program product.

2. Description of the Related Art

As a signaling protocol that is used for intermediating among communication apparatuses and is used for controlling and relaying communication, the Session Initiation Protocol (SIP) is widely known. In a communication system that uses the SIP (hereinafter, an “SIP system”), an SIP proxy is used as a communication intermediate server apparatus to intermediate among SIP terminals that are each configured with a terminal device. In the following explanation, the SIP terminals and the SIP proxy will be each referred to as an SIP entity.

As disclosed in J. Rosenberg et al. “RFC 3261, SIP: Session Initiation Protocol”, [Online], June 2002, retrieved from the Internet: <URL: http://www.ietf.org/rfc/rfc3261.txt>, a method is known by which, to ensure security between SIP entities, a Transport Layer Security (TLS) protocol is used as a transport protocol for connecting SIP terminals and an SIP proxy to one another.

TLS is a connection-oriented secure transport protocol. To deliver an SIP message by using TLS, the SIP entities need to perform a TLS handshake with each other so as to establish a connection.

Next, with regard to an SIP system including SIP terminals A and C and an SIP proxy B, an overview of a process that is performed when an SIP message is transmitted from the SIP terminal A to the SIP terminal C will be explained.

First, the SIP terminal A executes a TLS handshake protocol with the SIP proxy B. As a result, a secure connection is established between the SIP terminal A and the SIP proxy B. Next, the SIP terminal A transmits the SIP message that is encrypted using TLS to the SIP proxy B, by using the established secure connection.

The SIP proxy B receives the encrypted SIP message and performs a TLS decryption on the received message so as to obtain the SIP message. The SIP proxy B then refers to a Request Uniform Resource Identifier (Request-URI) contained in the SIP header and judges the delivery destination of the SIP message. To judge the delivery destination, the SIP proxy B may make an inquiry to an SIP location server. In the present example, the SIP proxy B judges that the delivery destination is the SIP terminal C. The SIP proxy B executes the TLS handshake protocol with the SIP terminal C, which is the delivery destination of the SIP message. As a result, a secure connection is established between the SIP proxy B and the SIP terminal C.

Subsequently, the SIP proxy B transmits the SIP message that is encrypted using TLS to the SIP terminal C, by using the established secure connection. The SIP terminal C then transmits an SIP response message by using the secure connection that has been established with the SIP proxy B. The SIP proxy B delivers the received SIP response message, by using the secure connection that has been established with the SIP terminal A.

As explained above, in order for the SIP proxy B to transmit and receive the SIP messages, the SIP proxy B needs to establish the connections by executing the TLS handshake protocol with each of the SIP terminals. When the TLS handshake protocol is used so that the plurality of messages are transmitted and received, it takes a certain period of time to perform the process of establishing the secure connections using the TLS handshake protocol (hereinafter, “TLS connections”).

In addition, generally speaking, the SIP proxy is not able to identify the SIP terminal being the delivery destination of an SIP message, until the SIP proxy receives the SIP message and refers to the SIP header (commonly known as a Request-URI). Thus, the SIP proxy needs to establish a TLS connection with the SIP terminal being the delivery destination, after having received the SIP message and identifying the delivery destination.

However, the conventional method disclosed in the publication by J. Rosenberg et al. has a problem where it takes time before the SIP message is delivered, and there is a long delay in the delivery of the SIP message.

In view of this problem, the present invention focuses on an SIP sequence called call forwarding. Call forwarding is an SIP sequence for forwarding, to an SIP terminal D, an SIP message that has been delivered from the SIP terminal A to the SIP terminal C. Call forwarding is performed in a case where, for example, a user U1 transmits an SIP message to a user U2 by using the SIP terminal A, and if the user U2 is using the SIP terminal D when the SIP message has been transmitted from the SIP terminal A to the SIP terminal C, so that the destination of the SIP message transmitted from the SIP terminal A needs to be changed from the SIP terminal C to the SIP terminal D.

In this situation, the SIP proxy B needs to establish TLS connections by executing a handshake protocol, not only with the SIP terminal A and with the SIP terminal C, but also with the SIP terminal D. As explained above, because it takes a certain period of time to perform the process of establishing each TLS connection, when call forwarding is performed so that the process of establishing a TLS connection needs to be performed a plurality of times, there will be a long delay in the delivery of the SIP message according to the conventional communication method.

### SUMMARY OF THE INVENTION

According to one aspect of the present invention, a relaying apparatus establishes communication with terminal devices and relays messages to be transmitted and received among the terminal devices by using the established communication.

The relaying apparatus includes a transmitting/receiving unit that receives a first message transmitted by a first terminal device and transmits the first message to a second terminal device; an estimating unit that estimates whether a delivery destination of a second message to be transmitted by the second terminal device after the second terminal device receives the first message is the first terminal device, based on a type of the first message; an obtaining unit that obtains identification information from the first message when the estimating unit has estimated that the delivery destination of the second message is not the first terminal device, the identification information identifying a delivery destination terminal device that is the delivery destination of the second message; and an establishing unit that establishes communication with the delivery destination terminal device, after the first message has been transmitted to the second terminal device and before the second message is received from the second terminal device, wherein the transmitting/receiving unit transmits the second message to the delivery destination terminal device after receiving the second message, by using the communication established with the delivery destination terminal device.

According to another aspect of the present invention, a communication method is performed in a relaying apparatus that establishes communication with terminal devices and relays messages to be transmitted and received among the terminal devices by using the established communication.

The communication method includes receiving a first message to be delivered to a second terminal device from a first terminal device; estimating whether a delivery destination of a second message to be transmitted by the second terminal device after the second terminal device receives the first message is the first terminal device, based on a type of the first message; obtaining identification information from the first message when it has been estimated that the delivery destination of the second message is not the first terminal device, the identification information identifying a delivery destination terminal device that is the delivery destination of the second message; transmitting the first message to the second terminal device; establishing communication with the delivery destination terminal device after the first message has been transmitted to the second terminal device and before the second message is received from the second terminal device; and transmitting the second message to the delivery destination terminal device after receiving the second message, by using the communication established with the delivery destination terminal device.

A computer program product according to still another aspect of the present invention causes a computer to perform the method according to the present invention.

### BRIEF DESCRIPTION OF THE DRAWINGS

FIG. 1 is a diagram illustrating an SIP system according to a first embodiment of the present invention;

FIG. 2 is a block diagram of an SIP proxy according to the first embodiment;

FIG. 3 is a block diagram of an SIP terminal according to the first embodiment;

FIG. 4 is a flowchart of an overall procedure in a call forwarding process according to the first embodiment;

FIG. 5 is a flowchart of a procedure in an establishing process for establishing a TLS connection according to the first embodiment;

FIG. 6 is a flowchart of a procedure in a delivery process according to the first embodiment;

FIG. 7 is a flowchart of an overall procedure in a call forwarding process according to a second embodiment of the present invention; and

FIG. 8 is a drawing for explaining a hardware configuration of a relaying apparatus according to the first embodiment or the second embodiment.

### DETAILED DESCRIPTION OF THE INVENTION

Exemplary embodiments of the present invention will be explained with reference to the accompanying drawings.

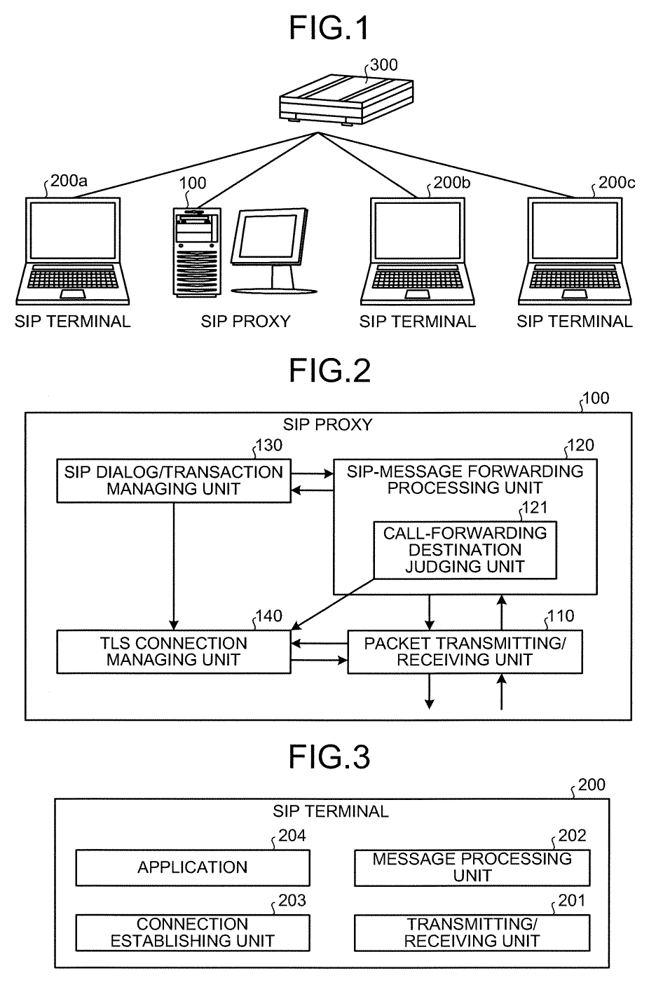

A first embodiment of the present invention will be explained with reference to FIGS. 1 to 6. First, a configuration of an SIP system according to the first embodiment will be explained, with reference to FIG. 1.

In the SIP system shown in FIG. 1, an SIP proxy 100 and a plurality of SIP terminals (namely, SIP terminals 200a, 200b, and 200c) are connected to one another via a router 300. Because the SIP terminals 200a, 200b, and 200c have the same configuration as one another, these SIP terminals may simply be referred to as the SIP terminals 200 in the following explanation.

The SIP proxy 100 is a relaying apparatus that relays an SIP message among the SIP terminals 200. The SIP proxy 100 establishes TLS connections by using a TLS protocol and relays the SIP message through the TLS connections. The detailed configuration of the SIP proxy 100 will be explained later.

The SIP terminals 200a, 200b, and 200c are each a terminal device that uses the SIP as a signaling protocol and has a User Agent (UA) function of the SIP. The number of SIP terminals 200 to be connected to one another is not limited to three. The detailed configuration of the SIP terminals 200 will be explained later.

The router 300 transfers IP packets among the SIP terminals 200 and the SIP proxy 100. The router 300 may be configured with a device that has conventionally been used, such as an IP router/switch.

Next, the detailed configuration of the SIP proxy 100 will be explained, with reference to FIG. 2. As shown in FIG. 2, the SIP proxy 100 includes: a packet transmitting/receiving unit 110; an SIP-message forwarding processing unit 120 including a call-forwarding destination judging unit 121; an SIP dialog/transaction managing unit 130; and a TLS connection managing unit 140.

The packet transmitting/receiving unit 110 includes an interface for a network. The packet transmitting/receiving unit 110 receives an SIP message from the SIP-message forwarding processing unit 120, encrypts the received SIP message, and transmits the encrypted SIP message to the network. Also, the packet transmitting/receiving unit 110 receives an SIP message from an SIP terminal 200, decrypts the received SIP message, and outputs the decrypted SIP message to the SIP-message forwarding processing unit 120. The packet transmitting/receiving unit 110 obtains, from the TLS connection managing unit 140, information that is required in the encryption and the decryption processes as well as information that is related to the TLS connections and is required in the transmission and the reception of the SIP messages. In a case where the packet transmitting/receiving unit 110 is to transmit or receive data to or from an SIP terminal with which no TLS connection has yet been established, the packet transmitting/receiving unit 110 requests the TLS connection managing unit 140 that a TLS connection should be established.

The SIP-message forwarding processing unit 120 performs a process for delivering the SIP messages, which is one of basic functions of an SIP proxy server. More specifically, the SIP-message forwarding processing unit 120 interprets the SIP message data received from the packet transmitting/receiving unit 110, according to the basic specifications of an SIP proxy that are disclosed in, for example, the publication by J. Rosenberg et al. so as to identify the delivery destination and also assembles the SIP message to be delivered. The assembled message is forwarded to the packet transmitting/receiving unit 110 and is transmitted to the delivery destination. As a result of the interpretation and the assembly of the message, if it is necessary to maintain and manage information related to the SIP dialog and the SIP transaction, the SIP-message forwarding processing unit 120 informs the SIP dialog/transaction managing unit 130 of the information related to the dialog and the transaction.

The call-forwarding destination judging unit 121 refers to the SIP message that has been interpreted by the SIP-message forwarding processing unit 120 and estimates whether the delivery of the SIP message will require call forwarding. In a case where the call-forwarding destination judging unit 121 has estimated that the call forwarding will be required, the call-forwarding destination judging unit 121 identifies the destination of the call forwarding. To establish a TLS connection with the SIP terminal 200 that has been identified as the destination of the call forwarding, the call-forwarding destination judging unit 121 instructs the TLS connection managing unit 140 that the TLS connection should be established.

The SIP dialog/transaction managing unit 130 manages SIP dialogs and transactions that need to be maintained and managed by the SIP proxy 100. The managing process is performed based on the information of dialogs and transactions provided by the SIP-message forwarding processing unit 120. The managing process for the SIP dialogs and transactions includes, for example, managing a timer for performing a re-sending process of an SIP message, instructing the SIP-message forwarding processing unit 120 to re-send an SIP message, managing a timer for discarding a TLS connection, and instructing the TLS connection managing unit 140 to discard a TLS connection.

The TLS connection managing unit 140 maintains and manages TLS connections. More specifically, the TLS connection managing unit 140 has the functions to execute a TLS handshake protocol, to store therein encryption parameters used in the encryption and the decryption processes, and to establish and discard TLS connections according to a request from other constituent elements.

Next, the detailed configuration of the SIP terminals 200 will be explained, with reference to FIG. 3. As shown in FIG. 3, each of the SIP terminals 200 includes a transmitting/receiving unit 201, a message processing unit 202, a connection establishing unit 203, and an application 204.

The transmitting/receiving unit 201 transmits and receives a message to and from an external apparatus. For example, when transmitting an SIP message, the transmitting/receiving unit 201 receives SIP message data from the message processing unit 202 and requests the connection establishing unit 203 that a TLS connection to be used for transmitting the SIP message should be established. In a case where a usable TLS connection is already present and is managed by the connection establishing unit 203, the transmitting/receiving unit 201 obtains information related to the TLS connection from the connection establishing unit 203. After encrypting the SIP message by using an encryption parameter associated with the TLS connection, the transmitting/receiving unit 201 transmits the SIP message to the network.

Also, when having received an SIP message, the transmitting/receiving unit 201 identifies an encryption parameter associated with the TLS connection that has been established by the connection establishing unit 203 and used for the reception of the SIP message and decrypts the received SIP message by using the identified encryption parameter. The transmitting/receiving unit 201 then forwards the decrypted SIP message data to the message processing unit 202.

The message processing unit 202 constructs an SIP message according to the basic specifications of an SIP User Agent (UA) that are, for example, disclosed in the publication by J. Rosenberg et al. and causes the transmitting/receiving unit 201 to transmit the constructed SIP message. Also, the message processing unit 202 interprets an SIP message received through the transmitting/receiving unit 201. The construction and the interpretation processes of the SIP messages are performed in response to a request from the application 204.

Like the TLS connection managing unit 140 included in the SIP proxy 100, the connection establishing unit 203 maintains and manages TLS connections. For example, the connection establishing unit 203 has the functions to execute a TLS handshake protocol and to store therein encryption parameters used in the encryption and the decryption processes of TLS.

The application 204 is an application that includes a function to operate by transmitting/receiving messages by using the SIP. For example, the application 204 may be an application that is used on a terminal side in an enterprise Voice over IP system that uses the SIP or an application that is used in an unified communication system that uses the SIP.

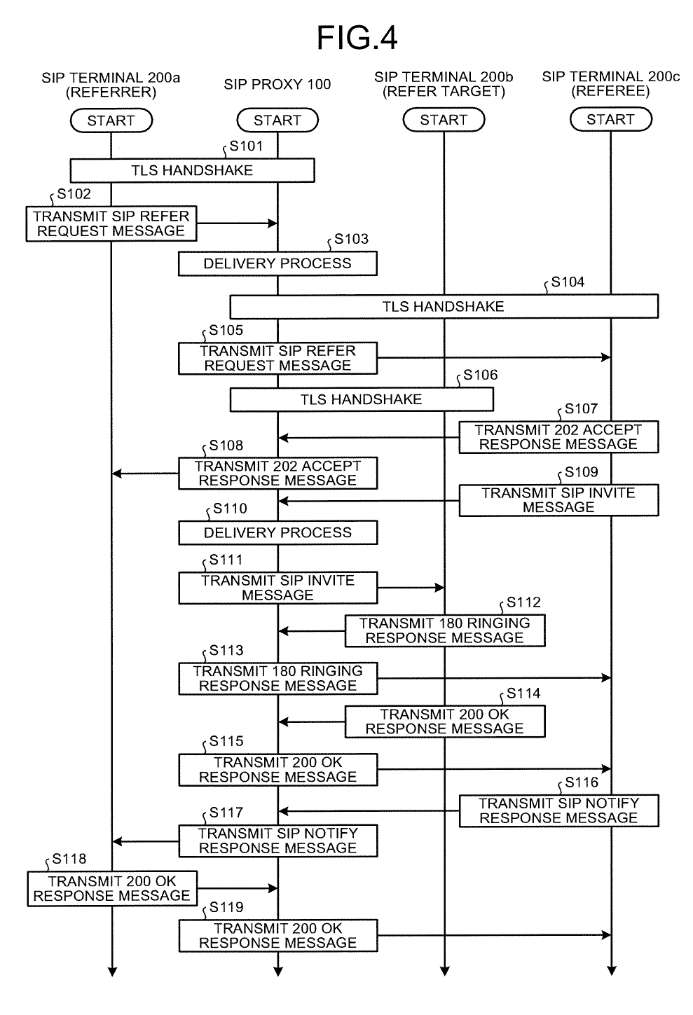

Next, the call forwarding process performed by the SIP proxy 100 according to the first embodiment will be explained, with reference to FIG. 4. In the following section, an example in which the SIP terminal 200a instructs the SIP terminal 200c that communication should be established with the SIP terminal 200b will be explained. This example corresponds to a situation in which a user A who is using the SIP terminal 200a receives a call from a user C who is using the SIP terminal 200c, and the user A wishes to forward the call to a user B who is using the SIP terminal 200b. In the explanation below, the example in which the SIP terminal 200a gives an instruction is used; however, it is possible to apply the present invention to a situation in which the SIP terminal 200b or the SIP terminal 200c gives the instruction.

First, the SIP terminal 200a executes a handshake protocol with the SIP proxy 100 and establishes a TLS connection (step S101). The details of the establishing process for establishing the TLS connection will be explained later.

The SIP terminal 200a transmits an SIP REFER request message to the SIP proxy 100 by using the established TLS connection. The contact header of the SIP REFER request message contains information of the SIP terminal 200b to which an SIP message should be transmitted from the SIP terminal 200c (step S102).

The SIP proxy 100 receives the SIP REFER request message transmitted from the SIP terminal 200a and performs a delivery process. The details of the delivery process will be explained later. By performing the delivery process, the SIP proxy 100 judges that the delivery destination of the SIP REFER request message is the SIP terminal 200c and also estimates that the delivery destination of a next message to be transmitted from the SIP terminal 200c will be the SIP terminal 200b (step S103).

Next, the SIP proxy 100 executes a handshake protocol with the SIP terminal 200c being the delivery destination of the SIP REFER request message and establishes a TLS connection (step S104). In a case where a TLS connection has already been established with the SIP terminal 200c, this step is omitted.

The SIP proxy 100 transmits the SIP REFER request message to the SIP terminal 200c, by using the established TLS connection (step S105).

After the SIP proxy 100 has transmitted the SIP REFER request message but before the SIP terminal 200c transmits the next message, the SIP proxy 100 executes a handshake protocol with the SIP terminal 200b that has been estimated, at step S103, to be the delivery destination of the next message and establishes a TLS connection (step S106).

When having received the SIP REFER request message, the SIP terminal 200c creates a 202 ACCEPT response message to be delivered to the SIP terminal 200a. The SIP terminal 200c then transmits the created message to the SIP proxy 100, by using the TLS connection that has already been established (step S107).

When having received the 202 ACCEPT response message from the SIP terminal 200c, the SIP proxy 100 performs the delivery process (not shown) and transmits the 202 ACCEPT response message to the SIP terminal 200a, by using the TLS connection that has already been established with the SIP terminal 200a (step S108).

When having received the SIP REFER request message at step S105, the SIP terminal 200c interprets the received message and determines that the SIP terminal 200c should communicate with the SIP terminal 200b. Accordingly, the SIP terminal 200c creates an SIP INVITE message that is to be delivered to the SIP terminal 200b and transmits the created message to the SIP proxy 100, by using the TLS connection that has already been established (step S109).

When having received the SIP INVITE request message that has been transmitted from the SIP terminal 200c, the SIP proxy 100 performs the delivery process and judges that the delivery destination of the SIP INVITE request message is the SIP terminal 200b (step S110).

The SIP proxy 100 has already established the TLS connection with the SIP terminal 200b at step S110. Thus, the SIP proxy 100 transmits the SIP INVITE request message to the SIP terminal 200b, by using the TLS connection that has already been established (step S111).

When having received the SIP INVITE request message, the SIP terminal 200b calls the user C and transmits a 180 RINGING message to the SIP proxy 100, by using the TLS connection that has already been established (step S112).

When having received the 180 RINGING message from the SIP terminal 200b, the SIP proxy 100 performs the delivery process (not shown) and transmits the 180 RINGING message to the SIP terminal 200c, by using the TLS connection that has already been established with the SIP terminal 200c (step S113).

When the user B responds to the call from the SIP terminal 200b, the SIP terminal 200b creates a 200 OK response message to be delivered to the SIP terminal 200c and transmits the created message to the SIP proxy 100 by using the TLS connection that has already been established (step S114).

When having received the 200 OK response message from the SIP terminal 200b, the SIP proxy 100 performs the delivery process (not shown) and transmits the 200 OK response message to the SIP terminal 200c, by using the TLS connection that has already been established with the SIP terminal 200c (step S115).

When communication has been established with the SIP terminal 200b, the SIP terminal 200c creates an SIP NOTIFY response message that is to be delivered to the SIP terminal 200a and transmits the created message to the SIP proxy 100 by using the TLS connection that has already been established (step S116).

When having received the SIP NOTIFY response message from the SIP terminal 200a, the SIP proxy 100 performs the delivery process (not shown) and transmits the SIP NOTIFY response message to the SIP terminal 200a, by using the TLS connection that has already been established with the SIP terminal 200a (step S117).

When having received the SIP NOTIFY response message, the SIP terminal 200a creates a 200 OK response message that is to be delivered to the SIP terminal 200c and transmits the created message to the SIP proxy 100, by using the TLS connection that has already been established (step S118).

When having received the 200 OK response message from the SIP terminal 200a, the SIP proxy 100 performs the delivery process (not shown) and transmits the 200 OK response message to the SIP terminal 200c, by using the TLS connection that has already been established with the SIP terminal 200c (step S119).

As a result of the processes described above, the SIP proxy 100 has performed a call forwarding process for forwarding the call from the SIP terminal 200a to the SIP terminal 200c.

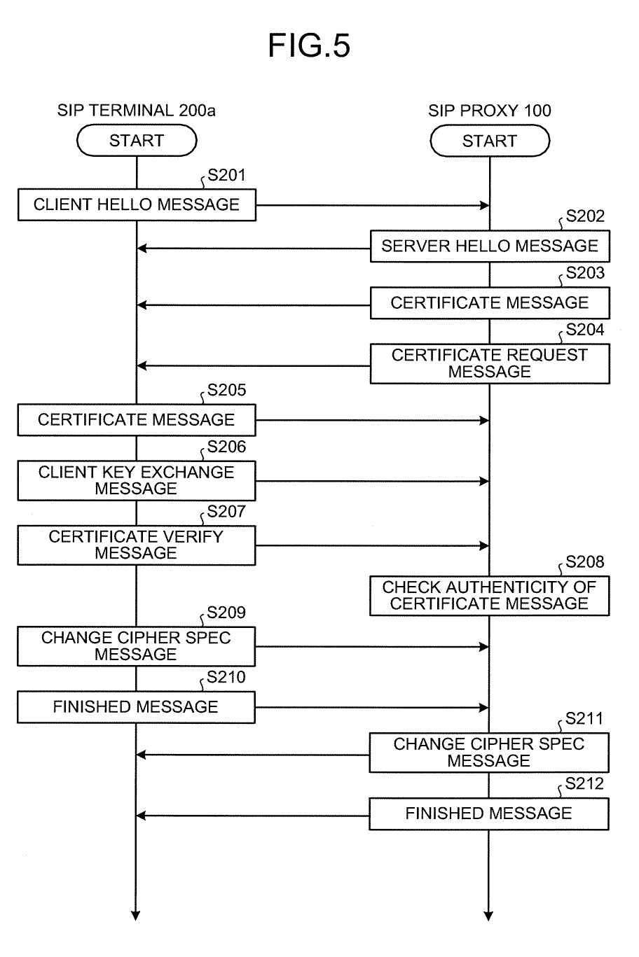

Next, the details of the establishing process for establishing a TLS connection by executing the handshake protocol will be explained, with reference to FIG. 5. In the following section, an example of the establishing process that is performed in advance before the SIP terminal 200a transmits an SIP message to the SIP proxy 100 will be explained. Other examples of the establishing process that are performed before another SIP terminal 200 or the SIP proxy 100 transmits an SIP message are the same as the procedure shown in FIG. 5. Thus, the explanation thereof will be omitted.

First, the SIP terminal 200a informs the SIP proxy 100 of a CLIENT HELLO message that contains a list of usable algorithms (step S201).

Next, the SIP proxy 100 selects an encryption algorithm to be used in the communication, out of the list of encryption algorithms indicated in the CLIENT HELLO message that has been received at step S201 and stores therein a corresponding encryption parameter. The SIP proxy 100 transmits a SERVER HELLO message to the SIP terminal 200a so as to inform the SIP terminal 200a of the selected encryption algorithm (step S202).

Further, the SIP proxy 100 transmits a CERTIFICATE message that guarantees the identity thereof to the SIP terminal 200a (step S203) and also transmits, to the SIP terminal 200a, a CERTIFICATE REQUEST message requesting that a certificate guaranteeing the identity of the SIP terminal 200a should be transmitted to the SIP proxy 100 (step S204).

When having received the CERTIFICATE REQUEST message, the SIP terminal 200a transmits a certificate (i.e., a CERTIFICATE message) guaranteeing the identity thereof to the SIP proxy 100 (step S205).

Subsequently, the SIP terminal 200a encrypts a random number that has been created by the SIP terminal 200a and is used in the encryption process, by using a public key contained in the CERTIFICATE message that has been transmitted from the SIP proxy 100 at step S202. The SIP terminal 200a then transmits a CLIENT KEY EXCHANGE message that contains the public key used in the encryption process to the SIP proxy 100 (step S206).

Further, the SIP terminal 200a creates a digest message showing the contents of the communication at steps S201 through S206 and encrypts the digest message by using a secret key stored in the SIP terminal 200a. The SIP terminal 200a transmits the encrypted digest message, which is referred to as a CERTIFICATE VERIFY message, to the SIP proxy 100 (step S207).

When having received the CERTIFICATE VERIFY message, the SIP proxy 100 decrypts the CERTIFICATE VERIFY message by using the public key contained in the CERTIFICATE message that has been transmitted from the SIP terminal 200a at step S205. By performing this decryption process, the SIP proxy 100 checks authenticity of the CERTIFICATE message that has been transmitted from the SIP terminal 200a at step S205 (step S208).

Further, the SIP terminal 200a transmits a CHANGE CIPHER SPEC message and notifies that the encryption algorithm indicated at step S202 will be used in the communication thereafter (step S209).

Subsequently, the SIP terminal 200a transmits a FINISHED message so as to inform the SIP proxy 100 that the authentication process has successfully been performed and that the series of handshake protocols has properly been executed (step S210).

The CHANGE CIPHER SPEC message is transmitted from the SIP proxy 100 to the SIP terminal 200a (step S211). Similarly, the FINISHED message is also transmitted from the SIP proxy 100 to the SIP terminal 200a (step S212).

As explained above, the SIP terminal 200a establishes the TLS connection with the SIP proxy 100 by exchanging the messages with the SIP proxy 100 a plurality of times. Although it depends on the hardware configurations of the SIP terminal 200a and the SIP proxy 100, it takes approximately 72 milliseconds to perform the establishing process for establishing a TLS connection, when typical hardware configurations are used.

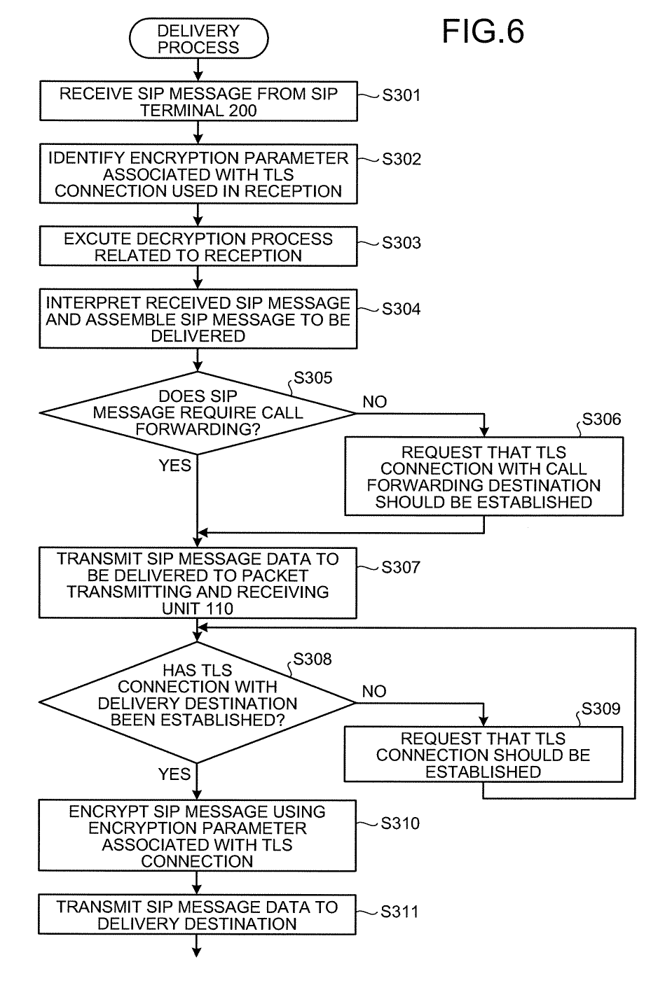

Next, the details of the delivery process will be explained, with reference to FIG. 6.

When the SIP terminal 200 has transmitted an SIP message (e.g., the SIP INVITE request message or the SIP REFER request message mentioned above), the packet transmitting/receiving unit 110 shown in FIG. 2 receives the SIP message (step S301).

The packet transmitting/receiving unit 110 makes an inquiry to the TLS connection managing unit 140 so as to identify the encryption parameter that is associated with the TLS connection used in the reception of the message (step S302).

The packet transmitting/receiving unit 110 then executes a decryption process on the SIP message, by using the encryption parameter that has been identified at step S302 (step S303).

After the decryption process has been performed thereon, the SIP message is forwarded from the packet transmitting/receiving unit 110 to the SIP-message forwarding processing unit 120. The SIP-message forwarding processing unit 120 interprets the received SIP message and assembles an SIP message to be delivered (step S304).

In this situation, the call-forwarding destination judging unit reads the SIP message that has been interpreted by the SIP-message forwarding processing unit 120. The call-forwarding destination judging unit 121 refers to the SIP message and estimates whether call forwarding will be required. The projection process is performed based on the type of the SIP message. For example, at step S103 shown in FIG. 4, the call-forwarding destination judging unit 121 estimates that call forwarding will be required because the received message is an SIP REFER request message (step S305).

In a case where the call-forwarding destination judging unit 121 has estimated at step S305 that call forwarding will be required, the call-forwarding destination judging unit 121 refers to the SIP URI contained in the contact header and estimates to which SIP terminal 200 a next SIP message will be delivered. Further, to establish a TLS connection with the SIP terminal 200 that has been estimated to be the delivery destination, the call-forwarding destination judging unit 121 requests the TLS connection managing unit 140 that a handshake protocol should be executed. For example, at step S103 shown in FIG. 4, the call-forwarding destination judging unit 121 refers to the contact header of the SIP REFER request message and requests the TLS connection managing unit 140 that a TLS connection should be established with the SIP terminal 200b that is identified with the SIP URI (step S306).

The SIP-message forwarding processing unit 120 forwards the SIP message to be delivered that has been assembled at step S204 to the packet transmitting/receiving unit 110 (step S307).

When having received the SIP message to be delivered, the packet transmitting/receiving unit 110 inquires of the connection managing unit 140 about whether a TLS connection has already been established with the SIP terminal 200 being the delivery destination (step S308).

As a result of the inquiry, in a case where the TLS connection has not been established, the packet transmitting/receiving unit 110 requests the TLS connection managing unit 140 that a TLS connection should be established with the SIP terminal 200 being the delivery destination (step S309).

On the other hand, in a case where the TLS connection has already been established, the packet transmitting/receiving unit 110 inquires of the connection managing unit 140 about information of the encryption parameter that is associated with the TLS connection. The packet transmitting/receiving unit 110 encrypts the SIP message to be delivered, by using the encryption parameter notified as a result of the inquiry (step S310).

Subsequently, the packet transmitting/receiving unit 110 transmits the SIP message to be delivered that has been encrypted, by using the TLS connection that has already been established (step S311).

As explained above, according to the first embodiment, the call-forwarding destination judging unit 121 estimates whether call forwarding will be required based on the type of the SIP message. In a case where it has been judged that call forwarding will be required, the call-forwarding destination judging unit 121 also estimates the destination of the call forwarding. With this arrangement, in the case where the delivery of the SIP message requires call forwarding, it is possible to establish, in advance, a TLS connection with the SIP terminal 200b being the destination of the call forwarding. Thus, it is possible to shorten the period of time it takes to perform the call forwarding process. It usually takes approximately 72 milliseconds to establish a TLS connection with the SIP terminal 200b. However, because it is possible to establish the connection during the period of time in which the next message to be transmitted from the SIP terminal 200c is waited for, it is possible to shorten the period of time it takes to perform the call forwarding process by a maximum of approximately 72 milliseconds.

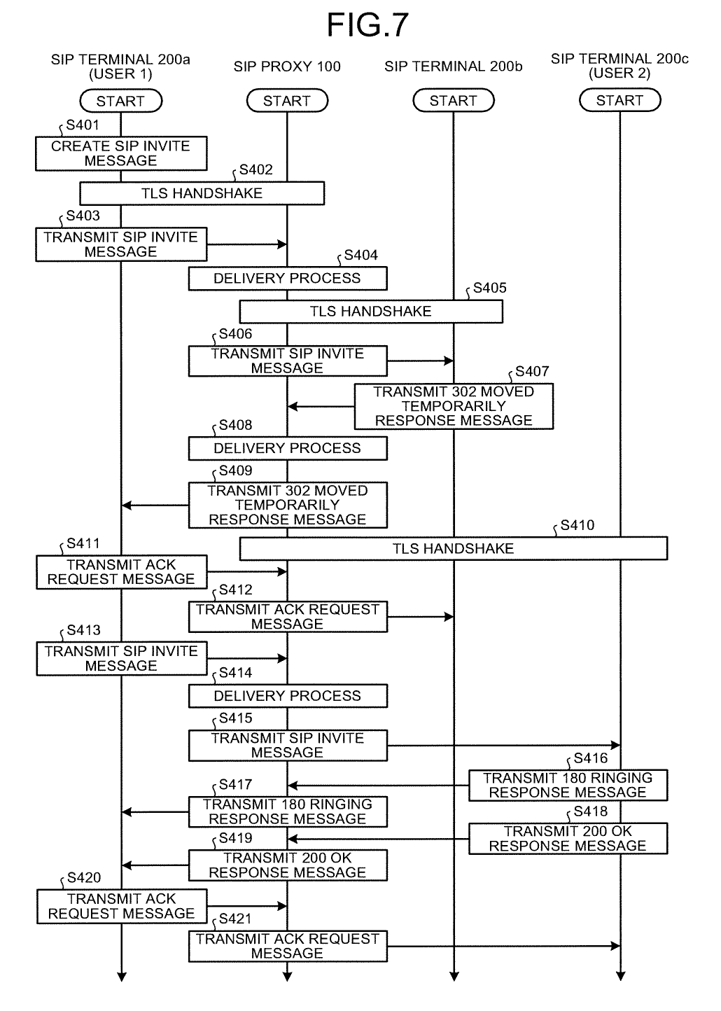

Next, a second embodiment of the present invention will be explained, with reference to FIG. 7. According to the second embodiment, an example will be used in which the user who is the delivery destination of an SIP message is temporarily using an SIP terminal 200 that is different from the one that is normally used. In this situation, call forwarding is required when it is instructed that the SIP message should be temporarily forwarded to the SIP terminal 200 that is different from the one that is normally used. The configurations and the operations of the SIP entities in the SIP system are the same as those shown in FIG. 1. Thus, the same reference characters will be used, and the explanation thereof will be omitted.

In the present example, it is assumed that the user A who is using the SIP terminal 200a is going to transmit an SIP message to the user C. An example will be explained in which, because the user C is temporarily using the SIP terminal 200c, which is different from the SIP terminal 200b that is normally used, the delivery destination of the SIP message should be changed from the SIP terminal 200b to the SIP terminal 200c, and call forwarding is therefore required.

To transmit the SIP message to be delivered to the SIP terminal 200b (i.e., the user C), the user A who is using the SIP terminal 200a creates an SIP INVITE request message that is to be delivered to the SIP terminal 200b (step S401).

Next, to transmit the created SIP INVITE request message to the SIP terminal 200b (i.e., the user C), the SIP terminal 200a executes a handshake protocol with the SIP proxy 100 and establishes a TLS connection (step S402). The TLS connection is established by using the same procedure as the one in the establishing process shown in FIG. 5.

The SIP terminal 200a transmits the SIP INVITE request message to the SIP proxy 100, by using the TLS connection that has been established (step S403).

When having received the SIP INVITE request message transmitted from the SIP terminal 200a, the SIP proxy 100 performs the delivery process and judges that the delivery destination of the SIP INVITE request message is the SIP terminal 200b (step S404). The delivery process at step S404 is the same as the procedure shown in FIG. 6.

Next, the SIP proxy 100 executes a handshake protocol with the SIP terminal 200b being the delivery destination of the SIP INVITE request message and establishes a TLS connection (step S405).

The SIP proxy 100 then transmits the SIP INVITE request message to the SIP terminal 200b, by using the TLS connection that has been established (step S406).

The SIP terminal 200b receives the SIP INVITE request message; however, because the user C who is the delivery destination of the SIP INVITE request message has moved to the SIP terminal 200c, the SIP terminal 200b transmits a 302 MOVED TEMPORARILY response message to the SIP proxy 100. The 302 MOVED TEMPORARILY response message has a contact header that contains the SIP URI of the SIP terminal 200c to which the user C has moved (step S407).

When having received the 302 MOVED TEMPORARILY response message from the SIP terminal 200b, the SIP proxy 100 performs the delivery process. In this situation, the SIP proxy 100 refers to the contact header of the 302 MOVED TEMPORARILY response message and estimates that the delivery destination to which a next SIP INVITE request message is to be delivered will be the SIP terminal 200c (step S408).

Subsequently, the SIP proxy 100 transmits the 302 MOVED TEMPORARILY response message to the SIP terminal 200a, by using the TLS connection that has been established (step S409).

After having transmitted the 302 MOVED TEMPORARILY response message but before receiving the next message, the SIP proxy 100 executes a handshake protocol and establishes a TLS connection with the SIP terminal 200c that has been estimated to be a delivery destination at step S408 (step S410).

When having received the 302 MOVED TEMPORARILY response message, the SIP terminal 200a creates an ACK request message to be delivered to the SIP terminal 200b and transmits the created message to the SIP proxy 100, by using the TLS connection that has been established (step S411).

When having received the ACK request message from the SIP terminal 200a, the SIP proxy 100 performs the delivery process (not shown) and transmits the ACK request message to the SIP terminal 200b, by using the TLS connection that has already been established with the SIP terminal 200b (step S412).

The SIP terminal 200a refers to the contact header of the 302 MOVED TEMPORARILY response message and judges, based on the SIP URI, that the SIP message to be delivered to the user C should be transmitted to the SIP terminal 200c. Accordingly, the SIP terminal 200a transmits, to the SIP proxy 100, an SIP INVITE request message to be delivered to the SIP terminal 200c, by using the TLS connection that has been established (step S413).

The SIP proxy 100 receives the SIP INVITE request message that has been transmitted from the SIP terminal 200a, performs the delivery process, and judges that the delivery destination of the SIP INVITE request message is the SIP terminal 200c (step S414).

The SIP proxy 100 has already established the TLS connection with the SIP terminal 200c at step S410. Thus, the SIP proxy 100 transmits the SIP INVITE request message to the SIP terminal 200c, by using the TLS connection that has already been established (step S415).

When having received the SIP INVITE request message, the SIP terminal 200c calls the user C and transmits a 180 RINGING message to the SIP proxy 100, by using the TLS connection that has been established (step S416).

When having received the 180 RINGING message from the SIP terminal 200c, the SIP proxy 100 performs the delivery process (not shown) and transmits the 180 RINGING message to the SIP terminal 200a, by using the TLS connection that has already been established with the SIP terminal 200a (step S417).

When the user C responses to the call from the SIP terminal 200c, the SIP terminal 200c creates a 200 OK response message to be delivered to the SIP terminal 200a and transmits the created message to the SIP proxy 100, by using the TLS connection that has already been established (step S418).

When having received the 200 OK response message from the SIP terminal 200c, the SIP proxy 100 performs the delivery process (not shown) and transmits the 200 OK response message to the SIP terminal 200a, by using the TLS connection that has already been established with the SIP terminal 200a (step S419).

When having received the 200 OK response message, the SIP terminal 200a creates an ACK request message to be delivered to the SIP terminal 200c and transmits the created message to the SIP proxy 100, by using the TLS connection that has already been established (step S420).

When having received the ACK request message from the SIP terminal 200a, the SIP proxy 100 performs the delivery process (not shown) and transmits the ACK request message to the SIP terminal 200c, by using the TLS connection that has already been established with the SIP terminal 200c (step S421).

By following the procedure described above, the SIP proxy 100 has performed the call forwarding process for forwarding the call from the SIP terminal 200b to the SIP terminal 200c.

As explained above, according to the second embodiment, it is possible to shorten the time it takes to perform the call forwarding process, not only in the case where the SIP REFER request message has been received, but also in the case where a message that requires call forwarding such as the 302 MOVED TEMPORARILY response message has been received. In the description above, the example in which the user moves between the SIP terminals is explained; however, it is possible to apply the present invention to an example in which information such as data moves instead of the user.

In the description of the exemplary embodiments above, the example in which the SIP is used as the signaling protocol is explained; however, the protocol to which the present invention is applicable is not limited to the SIP. It is possible to apply the present invention to any of the signaling protocols that have conventionally been used, such as H.323, the Media Gateway Control Protocol (MGCP), or the Media Gateway Control (Megaco). Also, in the description of the exemplary embodiments above, the example in which TLS is used as the encryption protocol is explained; however, another arrangement is acceptable in which another protocol such as Security Architecture for Internet Protocol (IPsec) is used. In the case where IPsec is used as the encryption protocol, for example, exchanging Internet Security Association and Key Management Protocol (ISAKMP) packets for starting a key exchange corresponds to a message requesting that a connection should be established (i.e., the handshake protocol in the TLS).

As explained above, according to the relaying apparatus according to the first embodiment or the second embodiment, it is possible to provide a relaying apparatus, a communication method, and a communication computer program that are able to reduce the delay during the delivery of SIP messages that is caused by call forwarding.

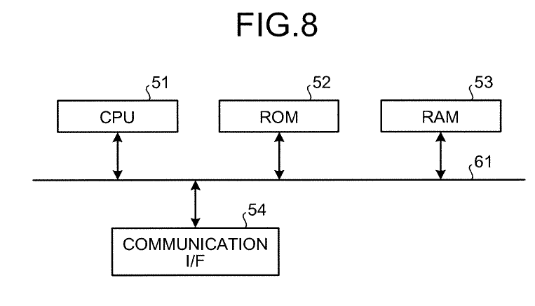

Next, the hardware configuration of the relaying apparatus according to the first embodiment or the second embodiment will be explained, with reference to FIG. 8.

The relaying apparatus according to the first embodiment or the second embodiment has a hardware configuration to which a commonly-used computer may be applied and that includes: a controlling device such as a Central Processing Unit (CPU) 51; storage devices such as a Read Only Memory (ROM) 52 and a Random Access Memory (RAM) 53; a communication interface (I/F) 54 that connects to the network and communicate; an external storage device such as a Hard Disk Drive (HDD) or a Compact Disc (CD) drive device; a display device such as a display monitor; an input device such as a keyboard or a mouse; and a bus 61 that connects these functional elements to one another.

The communication computer program that is executed by the relaying apparatus according to the first embodiment or the second embodiment is provided as being recorded on a computer-readable recording medium such as a Compact Disk Read-Only Memory (CD-ROM), a Flexible Disk (FD), a Compact Disk Recordable (CD-R), or a Digital Versatile Disk (DVD), in a file that is in an installable format or in an executable format.

Another arrangement is also acceptable in which the communication computer program executed by the relaying apparatus according to the first embodiment or the second embodiment is stored in a computer that is connected to a network such as the Internet and provided as being downloaded via the network. Yet another arrangement is acceptable in which the communication computer program executed by the relaying apparatus according to the first embodiment or the second embodiment is provided or distributed via a network such as the Internet.

Yet another arrangement is acceptable in which the communication computer program according to the first embodiment or the second embodiment is provided as being incorporated in the ROM or the like in advance.

The communication computer program executed by the relaying apparatus according to the first embodiment or the second embodiment has a module configuration that includes the functional elements explained above (e.g., the packet transmitting/receiving unit; the SIP-message forwarding processing unit; the TLS connection managing unit; the SIP dialog/transaction managing unit). In the actual hardware configuration, the CPU 51 (i.e., the processor) reads and executes the communication computer program from the storage device described above, so that the functional elements are loaded into the main storage device, and the functional elements are generated in the main storage device.

The present invention is not limited to the exemplary embodiments described above. At the embodiment stage, it is possible to embody the present invention by modifying the constituent elements without departing from the scope of the present invention. In addition, it is possible to form various different inventions by combining, as necessary, two or more of the constituent elements that are described in the exemplary embodiments above. For example, it is possible to eliminate one or more of the constituent elements used in the exemplary embodiments described above. Further, it is acceptable to combine, as necessary, one or more constituent elements from mutually different ones of the exemplary embodiments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A relaying apparatus that establishes communication with terminal devices and relays messages to be transmitted and received among the terminal devices by using the established communication, the relaying apparatus comprising:
a transmitting/receiving unit that receives a first message transmitted by a first terminal device and transmits the first message to a second terminal device;
an estimating unit that estimates whether a delivery destination of a second message to be transmitted by the second terminal device after the second terminal device receives the first message is the first terminal device, based on a type of the first message;
an obtaining unit that obtains identification information from the first message when the estimating unit has estimated that the delivery destination of the second message is not the first terminal device, the identification information identifying a delivery destination terminal device that is the delivery destination of the second message; and
an establishing unit that establishes communication with the delivery destination terminal device, after the first message has been transmitted to the second terminal device and before the second message is received from the second terminal device, wherein
the transmitting/receiving unit transmits the second message to the delivery destination terminal device after receiving the second message, by using the communication established with the delivery destination terminal device.

2. The apparatus according to claim 1, wherein
the estimating unit estimates that the delivery destination of the second message is the first terminal device when the first message is a message instructing that communication should be established with a terminal device other than the first terminal device, and
the obtaining unit obtains the identification information of the delivery destination terminal device that is indicated as a communication target in the instruction from the first terminal device.

3. The apparatus according to claim 1, wherein
the estimating unit estimates that the delivery destination of the second message is not the first terminal device when the first message is a message that notifies a move of information or a user from one place to another, and
the obtaining unit obtains the identification information of the delivery destination terminal device that is a destination of the move of the information or the user.

4. The apparatus according to claim 1, wherein the establishing unit establishes the communication with the delivery destination terminal device, based on a Transport Layer Security (TLS) protocol.

5. The apparatus according to claim 1, wherein the establishing unit establishes the communication with the delivery destination terminal device, based on an IPsec protocol.

6. The apparatus according to claim 2, wherein the estimating unit estimates that the delivery destination of the second message is not the first terminal device when the first message is a REFER request message according to a Session Initiation Protocol (SIP).

7. The apparatus according to claim 6, wherein the obtaining unit obtains the identification information from a header of the first message.

8. The apparatus according to claim 3, wherein the estimating unit estimates that the delivery destination of the second message is not the first terminal device when the first message is a MOVE TEMPORARILY response message according to a Session Initiation Protocol (SIP).

9. The apparatus according to claim 8, wherein the obtaining unit obtains the identification information from a header of the first message.

10. A communication method performed in a relaying apparatus that establishes communication with terminal devices and relays messages to be transmitted and received among the terminal devices by using the established communication, the communication method comprising:
receiving a first message to be delivered to a second terminal device from a first terminal device;
estimating whether a delivery destination of a second message to be transmitted by the second terminal device after the second terminal device receives the first message is the first terminal device, based on a type of the first message;
obtaining identification information from the first message when it has been estimated that the delivery destination of the second message is not the first terminal device, the identification information identifying a delivery destination terminal device that is the delivery destination of the second message;
transmitting the first message to the second terminal device;
establishing communication with the delivery destination terminal device after the first message has been transmitted to the second terminal device and before the second message is received from the second terminal device; and
transmitting the second message to the delivery destination terminal device after receiving the second message, by using the communication established with the delivery destination terminal device.

11. A computer program product having a computer readable medium including programmed instructions for establishing communication among terminal devices and relaying messages to be transmitted and received among the terminal devices by using the established communication, wherein the instructions, when executed by a computer, cause the computer to perform:
receiving a first message to be delivered to a second terminal device from a first terminal device;
estimating whether a delivery destination of a second message to be transmitted by the second terminal device after the second terminal device receives the first message is the first terminal device, based on a type of the first message;
obtaining identification information from the first message when it has been estimated that the delivery destination of the second message is not the first terminal device, the identification information identifying a delivery destination terminal device that is the delivery destination of the second message;
transmitting the first message to the second terminal device;
establishing communication with the delivery destination terminal device after the first message has been transmitted to the second terminal device and before the second message is received from the second terminal device; and
transmitting the second message to the delivery destination terminal device after receiving the second message, by using the communication established with the delivery destination terminal device.
